(19) United States
(12) Patent Application Publication
(10) Pub. No.: US 2024/0428427 A1
(43) Pub. Date: Dec. 26, 2024

(54) OBJECT TRACKING APPARATUS AND CONTROL METHOD THEREOF

(71) Applicant: CANON KABUSHIKI KAISHA, Tokyo (JP)

(72) Inventor: Shohei Funamoto, Tokyo (JP)

(21) Appl. No.: 18/828,536

(22) Filed: Sep. 9, 2024

Related U.S. Application Data
(63) Continuation of application No. 16/950,996, filed on Nov. 18, 2020.

(30) Foreign Application Priority Data
Nov. 21, 2019 (JP) 2019-210632

(51) Int. Cl. G06T 7/20

(52) U.S. Cl. CPC G06T 7/20; G06T 2207/10016

(57) ABSTRACT

An apparatus performs tracking processing that takes a predetermined object in images captured in succession as a tracking target, sets an object as the tracking target in accordance with a user operation, determines an object as the tracking target on the basis of at least one of the images, and performs control so that, in control that changes a current tracking target to the determined object, it is more difficult for the tracking target to be changed when the current tracking target has been set than when the current tracking target has not been set.

### CROSS-REFERENCE TO RELATED APPLICATION

This application is a continuation of application Ser. No. 16/950,996, filed Nov. 18, 2020, the entire disclosure of which is hereby incorporated by reference.

### BACKGROUND OF THE INVENTION

### Field of the Invention

The present invention relates to a control technique for tracking a specific object.

### Description of the Related Art

Some image capture apparatuses, such as digital cameras, have tracking AF functions, in which a main object region is extracted from continuously-captured images and tracked, and a focus state and exposure state are continuously optimized with respect to the main object. Methods for extracting the main object from a captured image in this tracking AF function include a method in which a user selects the main object, and a method in which the image capture apparatus automatically determines the main object from the captured image.

Japanese Patent Laid-Open No. 2019-117395 proposes a method in which a plurality of focus detection areas are provided, and when a user-selected focus detection area and a face detection position are in a predetermined positional relationship, the focus is adjusted in the focus detection area corresponding to the position of the face.

However, Japanese Patent Laid-Open No. 2019-117395 only considers a situation where the user intends to focus on a person, and does not appropriately consider situations where the user intends to focus on a variety of other objects which he or she may set.

### SUMMARY OF THE INVENTION

The present invention has been made in consideration of the aforementioned problems, and realizes a technique capable of selecting and changing a main object consistent with a user's intentions when continuously tracking a main object in continuously-captured images.

In order to solve the aforementioned problems, the present invention provides an object tracking apparatus comprising: a tracking unit configured to perform tracking processing that takes a predetermined object in images captured in succession as a tracking target; a setting unit configured to set an object as the tracking target in accordance with a user operation; a determining unit configured to determine an object as the tracking target on the basis of at least one of the images; and a control unit configured to perform control so that, in control that changes a current tracking target to the object determined by the determining unit, it is more difficult for the tracking target to be changed when the current tracking target has been set by the setting unit than when the current tracking target has not been set by the setting unit.

In order to solve the aforementioned problems, the present invention provides a method of controlling an object tracking apparatus which performs tracking processing that takes a predetermined object in images captured in succession as a tracking target, the method comprising: setting an object as the tracking target in accordance with a user operation; determining an object as the tracking target on the basis of at least one of the images; and performing control so that, in control that changes a current tracking target to the determined object, it is more difficult for the tracking target to be changed when the current tracking target has been set than when the current tracking target has not been set.

In order to solve the aforementioned problems, the present invention provides a non-transitory computer-readable storage medium storing a program for causing a computer to execute a method of controlling an object tracking apparatus which performs tracking processing that takes a predetermined object in images captured in succession as a tracking target, the method comprising: setting an object as the tracking target in accordance with a user operation; determining an object as the tracking target on the basis of at least one of the images; and performing control so that, in control that changes a current tracking target to the determined object, it is more difficult for the tracking target to be changed when the current tracking target has been set than when the current tracking target has not been set.

In order to solve the aforementioned problems, the present invention provides an object tracking apparatus comprising: a tracking unit configured to perform tracking processing that takes a predetermined object in images captured in succession as a tracking target; a setting unit configured to set an object as the tracking target in accordance with a user operation; a determining unit configured to determine an object as the tracking target on the basis of at least one of the images; and a control unit configured to perform control so that, in control that changes a current tracking target to the object determined by the determining unit, wherein when the current tracking target has been set by the setting unit, a change in the tracking target is suppressed until the suitability of a candidate object, among the candidate objects, that is the same object as the current tracking target drops below a predetermined threshold.

In order to solve the aforementioned problems, the present invention provides an object tracking apparatus comprising: a tracking unit configured to perform tracking processing that takes a predetermined object in images captured in succession as a tracking target; a setting unit configured to set an object as the tracking target in accordance with a user operation; a determining unit configured to determine an object as the tracking target on the basis of at least one of the images; and a control unit configured to perform control so that, in control that changes a current tracking target to the object determined by the determining unit, wherein when the current tracking target has been set by the setting unit, a change in the tracking target is suppressed until a predetermined length of time has elapsed following a point in time when tracking was started by the tracking unit.

According to the present invention, a main object consistent with a user's intentions can be selected and changed when continuously tracking a main object in continuously-captured images.

Further features of the present invention will become apparent from the following description of exemplary embodiments (with reference to the attached drawings).

### BRIEF DESCRIPTION OF THE DRAWINGS

FIG. 1 is an overall cross-sectional view of an optical system in an image capture apparatus according to first to fifth embodiments.

FIG. 2 is a block diagram illustrating the configuration of a control system of the image capture apparatus according to the first to fifth embodiments.

FIG. 3 is a diagram illustrating an example of a viewfinder screen of the image capture apparatus according to the first to fifth embodiments.

FIG. 4 is a flowchart illustrating continuous capturing operations performed by the image capture apparatus according to the first to fifth embodiments.

FIG. 5 is a diagram illustrating object tracking processing performed by the image capture apparatus according to the first to fifth embodiments.

FIGS. 6A to 6C are diagrams illustrating focus detection point selection processing performed by the image capture apparatus according to the first to fifth embodiments.

FIGS. 7A and 7B are flowcharts illustrating main object determination processing performed by the image capture apparatus according to the first embodiment.

FIG. 8 is a diagram illustrating parameters used in main object determination processing according to the first to fifth embodiments.

FIG. 9 is a diagram illustrating a method for calculating a main object suitability for a main object candidate, according to the first to fifth embodiments.

FIGS. 10A and 10B are diagrams illustrating main object selection processing performed in accordance with user operations, according to the first to fifth embodiments.

FIGS. 11A and 11B are diagrams illustrating automatic main object determination processing according to the first to fifth embodiments.

FIG. 12 is a diagram illustrating an example of correcting a main object suitability according to the first embodiment.

FIG. 13 is a diagram illustrating an example of correcting a main object suitability according to the first embodiment.

FIG. 14 is a flowchart illustrating main object determination processing performed by the image capture apparatus according to the second embodiment.

FIG. 15 is a diagram illustrating an example of associating a main object candidate according to the second embodiment.

FIG. 16 is a diagram illustrating an example of determining to change a main object according to the second embodiment.

FIG. 17 is a flowchart illustrating main object determination processing performed by the image capture apparatus according to the third embodiment.

FIG. 18 is a diagram illustrating an example of determining to change a main object according to the third embodiment.

FIG. 19 is a flowchart illustrating main object determination processing performed by the image capture apparatus according to the fourth embodiment.

FIG. 20 is a flowchart illustrating main object determination processing performed by the image capture apparatus according to the fifth embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

### First Embodiment

A first embodiment will be described hereinafter.

An example in which an image capture apparatus or an object tracking apparatus according to the present embodiment is applied in a digital single-lens reflex camera (“camera” below) will be described hereinafter. Note, however, that the image capture apparatus according to the present embodiment is not limited thereto, and can also be applied in a communication device such as a mobile phone or a smartphone, which is a type of mobile phone, in a portable information device such as a tablet terminal, or the like.

As a method through which an image capture apparatus or an object tracking apparatus automatically determines a main object, a method is known in which, for example, a specific object such as a person's face is detected from a captured image, a suitability of each detected object as a main object (“main object suitability” hereinafter) is determined, and the object having the highest suitability is taken as the main object.

However, when, for example, the user selects a main object and, at the same time, the image capture apparatus detects another object having a higher main object suitability than the object selected by the user, the image capture apparatus may have difficulty determining which object to set as the main object. There is a further issue in that if the appropriate main object is not selected in accordance with the situation, an object different from the one intended by the user will be set as the main object.

Accordingly, in the present embodiment, when a main object to be tracked has been selected by the user, control is performed so that it is more difficult for the object currently being tracked to be changed to another object to be tracked than when the main object has not been selected by the user (i.e., when the main object has automatically been determined and set by the image capture apparatus).

### Apparatus Configuration

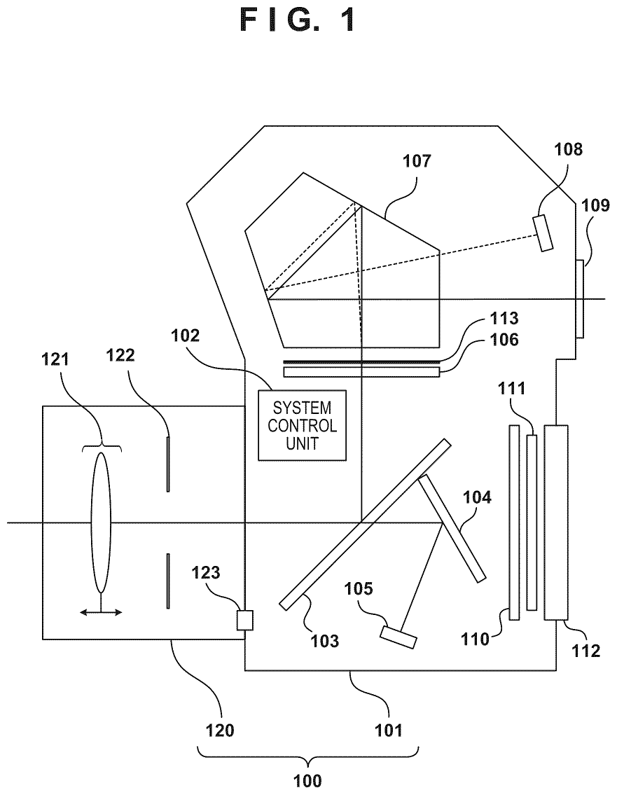

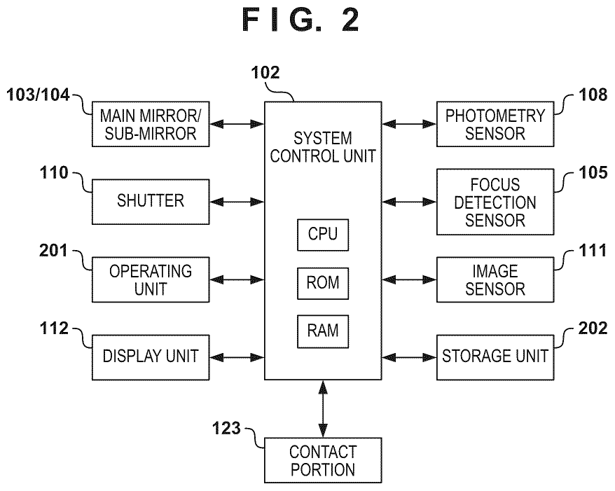

First, the configuration and functions of a camera 100 according to the present embodiment will be described with reference to FIGS. 1 to 3.

FIGS. 1, 2, and 3 illustrate the configuration of an optical system, the configuration of a control system, and a viewfinder screen, respectively, of the camera 100 according to the present embodiment.

The camera 100 according to the present embodiment has an interchangeable lens unit 120 detachably mounted to a front side (an object side) of a camera body 101. The lens unit 120 includes a focus lens 121, an aperture stop 122, and the like, and is electrically connected to the camera body 101 via a contact portion 123. The camera body 101 can adjust the light intensity of object image light captured in the camera body 101, the focal position, and the like by communicating with the lens unit 120 via the contact portion 123. Note that the focus lens 121 of the lens unit 120 can also be adjusted manually by the user.

A system control unit 102 includes a multi-core CPU capable of processing multiple tasks in parallel, RAM, and ROM, and controls the various units of the camera body 101 and the lens unit 120. The system control unit 102 also includes a processing circuit for generating image data from a signal output from an image sensor 111, for high-speed execution of processing to detect a specific object, such as a person's face, from an image, and the like.

A main mirror 103 guides an object light beam that enters an image capturing optical path and passes through the lens unit 120 to a focus plate 106 during viewfinder observation, and retracts from the image capturing optical path and guides the object light beam to the image sensor 111 during image capturing. The main mirror 103 is constituted by a half mirror, and a sub-mirror 104 reflects the object light beam transmitted through the main mirror 103 and guides the beam to a focus detection sensor 105.

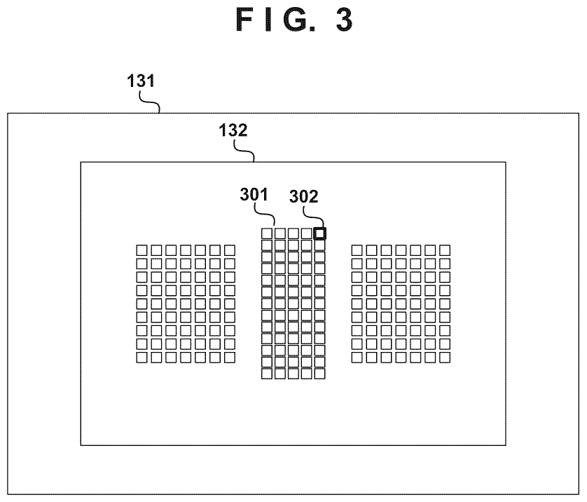

A roof pentaprism 107 converts the object light beam formed on the focus plate 106 into an erect normal image of the object, and the resulting object image is guided to a photometry sensor 108 while also being visible to the user through an optical viewfinder and an eyepiece 109. FIG. 3 illustrates an example of a viewfinder screen visible when the user looks into the optical viewfinder. Peripheral parts of the object light beam are blocked by a viewfinder visual field frame 113 disposed near the focus plate 106, and only a region captured by the image sensor 111 corresponds to a viewfinder screen 131 visible to the user.

The photometry sensor 108 receives a light beam from a photometry region 132 inside the viewfinder screen 131 illustrated in FIG. 3 and generates an AE (automatic exposure) image signal. The AE image signal generated by the photometry sensor 108 is transmitted to the system control unit 102. The system control unit 102 performs automatic exposure processing using the AE image signal received from the photometry sensor 108, and further performs object detection processing and tracking AF processing (described later).

By forming a secondary imaging surface for the object light beam on the focus detection sensor, the focus detection sensor 105 generates an AF image signal corresponding to 191 focus detection points 301, displayed as a rectangular AF frame in the viewfinder screen 131 illustrated in FIG. 3. The AF image signal generated by the focus detection sensor 105 is transmitted to the system control unit 102. The system control unit 102 performs AF (autofocus) processing by detecting the focus state of the focus lens 121 on the basis of the AF image signal received from the focus detection sensor 105 and controlling driving of the focus lens 121 on the basis of the result of the focus detection.

The image sensor 111 includes a photoelectric conversion element such as a CCD or a CMOS, an infrared cut filter, and a low-pass filter. The image sensor 111 is controlled by the system control unit 102, and transmits, to the system control unit 102, an image signal obtained by photoelectrically converting the object image formed through an optical imaging system of the lens unit 120. The system control unit 102 generates image data from the image signal received from the image sensor 111, stores the image data in a storage unit 202, and displays the image data in a display unit 112.

The display unit 112 includes a display panel such as an organic EL or liquid-crystal panel, and is capable of displaying images captured by the camera 100, various types of settings and operation menus, and the like. The storage unit 202 is a recording medium, such as a memory card or a hard disk, which is built into the camera 100 or which can be removed from the camera 100. The driving of a shutter 110 is controlled by the system control unit 102, so that the shutter 110 blocks light from the image sensor 111 when not in an image capturing mode (described later) but exposes the image sensor 111 when in the image capturing mode.

Operating units 201 are operating members such as various types of switches, buttons, a touch panel, and so on that accept various types of operations from a user. The operating units 201 include, for example, a power button, a mode changing button, and a shutter release button, detects a user operation, and transmits an operation signal based on the result of the detection to the system control unit 102. The power button is an operating member that switches the power of the camera 100 on and off. The mode changing button is an operating member that switches the operating mode of the camera 100. The “operating mode” of the camera 100 includes a live view mode, in which image signals are output from the image sensor 111 and displayed consecutively; an image capturing mode, in which still images and moving images are captured; a playback mode, in which captured images are played back; and the like. The user selects one of the operating modes using the mode changing button. Furthermore, in the image capturing mode, settings can be made for a tracking AF mode, in which object tracking processing (described later) is performed.

When the shutter release button is pressed halfway, a first switch SW1 turns on, and the system control unit 102 commences image capturing preparation processes such as AF (autofocus) processing, AE (autoexposure) processing, AWB (auto white balance) processing, and EF (flash pre-emission) processing. Additionally, when the shutter release button is fully depressed, a second switch SW2 turns on, and the system control unit 102 commences a series of image capturing processes, from reading out an image signal from the image sensor 111 to writing image data into the storage unit 202. When the shutter release button is not being pressed, the user can operate a dial or the like to set an arbitrary one of the 191 focus detection points 301 in the viewfinder screen 131 (FIG. 3) as an arbitrarily selected focus detection point 302. When the first switch SW1 is turned on while the arbitrarily selected focus detection point 302 is set, the system control unit 102 performs AF processing in accordance with the focus state detected at the arbitrarily selected focus detection point 302. Note that it is also possible for the user not to set the arbitrarily selected focus detection point 302, depending on camera settings or the like.

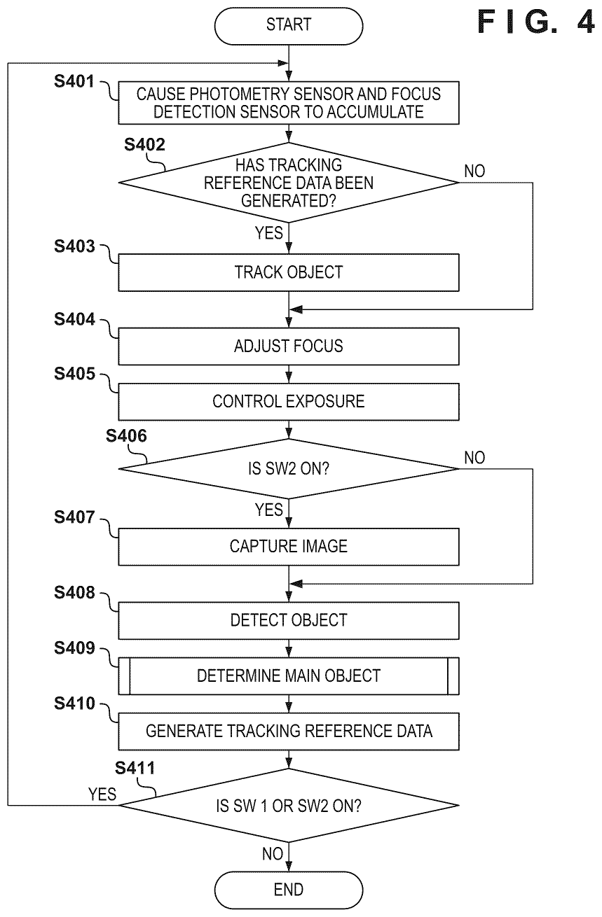

Continuous capturing operations in the tracking AF mode, in which the object tracking processing of the camera 100 according to the present embodiment is performed, will be described next with reference to FIGS. 4 to 6C.

FIG. 4 illustrates the flow of the continuous capturing operations in the tracking AF mode after the first switch SW1 has been turned on, performed by the camera 100 according to the present embodiment.

In FIG. 4, the processes from step S401 to step S411 are a series of processes equivalent to one frame's worth of continuous capturing, and continuous capturing is executed by repeating this series of processes. Note that the processing illustrated in FIG. 4 is realized by the CPU of the system control unit 102 deploying programs stored in the ROM into the RAM and executing those programs to control the various units of the camera 100.

In step S401, the system control unit 102 causes the photometry sensor 108 to accumulate a charge, and reads out an image signal generated as a result as the AE image signal. The system control unit 102 also causes the focus detection sensor 105 to accumulate a charge, and reads out an image signal generated as a result as the AF image signal. Once the system control unit 102 has finished reading out the AE image signal and the AF image signal, the processing moves to step S402.

In step S402, the system control unit 102 moves the processing to step S403 if, for a past frame, the main object region has been extracted in step S410 (described later) and tracking reference data for performing the tracking AF processing has been generated. On the other hand, if the first switch SW1 has only just been turned on and the tracking reference data has not yet been generated, the system control unit 102 moves the processing to step S404.

In step S403, the system control unit 102 uses the AE image signal read out in step S401 and the tracking reference data to perform tracking AF processing for tracking a specific object through a known color histogram matching method, and estimates the position of the main object. The estimated position of the main object region is then stored in the RAM as an object tracking region, and the processing then moves to step S404.

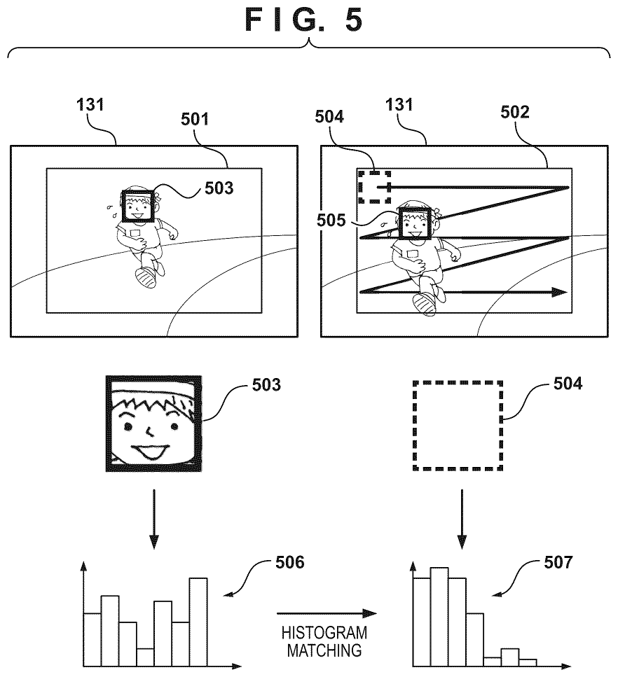

Here, a procedure for estimating the object tracking region through color histogram matching will be described with reference to FIG. 5.

AE image signals 501 and 502 are AE image signals captured in different frames. The AE image signal 501 is an AE image signal from a previous frame, and is an AE image signal on which main object extraction has been performed in step S410 (described later), and for which the tracking reference data has been generated. The AE image signal 502 is an AE image signal from the current frame, and is an AE image signal for which main object position estimation is performed through the tracking AF processing.

In the tracking AF processing, first, in a past frame, a main object region 503 is extracted from the AE image signal 501, and a reference color histogram 506 is generated on the basis of the values of pixels included in the main object region 503. The horizontal axis of the reference color histogram 506 represents types of colors classified on the basis of numerical values for hue, saturation, and luminance. The vertical axis of the reference color histogram 506 represents a number of pixels classified into each of the colors on the basis of the pixel values. The generated reference color histogram 506 continues to be stored in the RAM of the system control unit 102 until being overwritten by a new reference color histogram.

Next, in the current frame, a plurality of search regions 504 are extracted while raster-scanning the AE image signal 502, and a color histogram 507 is generated on the basis of the pixel values included in each search region 504. The horizontal axis and vertical axis of the color histogram 507 are the same as those of the reference color histogram 506.

Then, the congruency with the reference color histogram 506 is evaluated for all of the generated color histograms 507, and the search region corresponding to the color histogram 507 having the highest congruency is taken as an object tracking region 505 in the current frame.

Note that a known Bhattacharyya coefficient can be used as a method for evaluating the congruency between the two histograms.

In step S404, the system control unit 102 determines a main focus detection point and adjusts the focus of the focus lens 121 on the basis of the AF image signal read out in step S401 and the position of the object tracking region 505 detected in step S403, after which the processing moves to step S405.

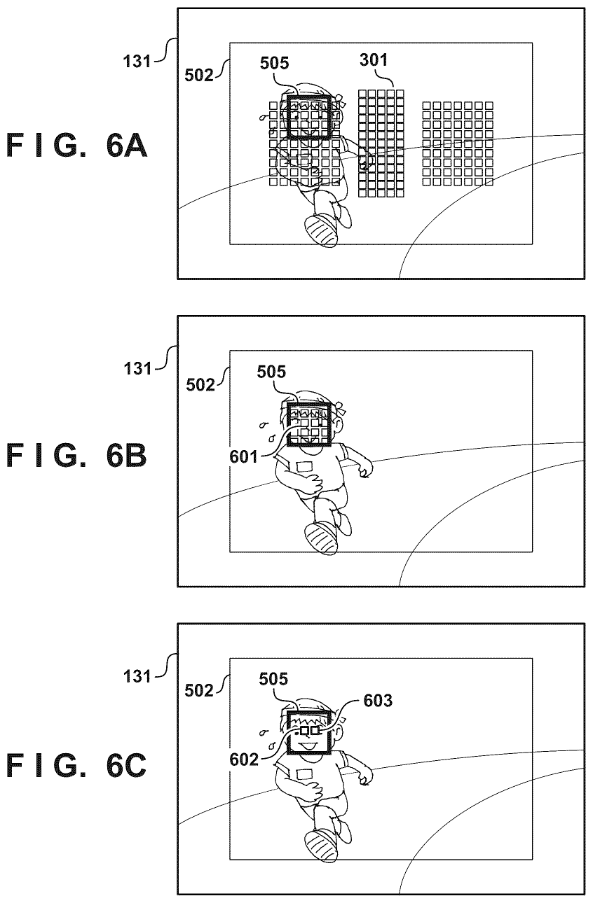

Processing for determining the main focus detection point on the basis of the position of the object tracking region 505 will be described here with reference to FIGS. 6A to 6C.

FIG. 6A illustrates an example of a state in which the 191 focus detection points 301 displayed in the viewfinder screen 131 are superimposed on the object tracking region 505 detected in step S403. First, the system control unit 102 extracts, from the 191 focus detection points 301, all the focus detection points that even partially overlap with the object tracking region 505 in the viewfinder screen 131.

FIG. 6B illustrates an example of a state in which focus detection points which overlap with the object tracking region 505 have been extracted from the 191 focus detection points 301. The system control unit 102 stores the extracted focus detection points in the RAM as main focus detection point candidates 601.

FIG. 6C illustrates an example of a method for selecting a single main focus detection point from the main focus detection point candidates 601. The system control unit 102 sorts the focus detection points included in the main focus detection point candidates 601 on the basis of the surface areas of the corresponding AF frames, in order from points having higher ratios of surface areas which overlap with the object tracking region 505. If there are a plurality of focus detection points having equivalent overlapping surface area ratios, those focus detection points are furthermore sorted in order from focus detection points closer to the center of the object tracking region 505. The system control unit 102 then ranks the main focus detection point candidates 601 sorted in this manner, in order from the top.

Then, using the AF image signal obtained in step S401, the system control unit 102 performs focus detection computations on a focus detection point 602 which, of the ranked main focus detection point candidates 601, has the highest rank. If the focus has been successfully detected as a result of the computations, the focus detection point 602 is taken as the main focus detection point.

If the focus could not be detected for the focus detection point 602 due to factors such as the contrast being lower than a predetermined contrast, the focus detection computations are performed for a focus detection point 603, which has the second-highest ranking among the ranked main focus detection point candidates 601. If the focus has been successfully detected as a result of the focus detection computations, the focus detection point 603 is taken as the main focus detection point.

If the focus could not be detected for the focus detection point 603 either, the same focus detection computations are repeated for the third, fourth, and subsequent points in the ranking until the focus is successfully detected, and the main focus detection point is determined. If the focus could not be detected for all of the focus detection points included in the main focus detection point candidates 601, the focus detection computations are performed on the remaining focus detection points among the 191 focus detection points 301 which are not included in the main focus detection point candidates 601. Then, the focus detection point, among the remaining focus detection points, which has a focal position closest to a predicted focal position of the main object is then taken as the main focus detection point.

Finally, the system control unit 102 adjusts the focal position of the focus lens 121 on the basis of the focus state of the main focus detection point.

Note that in a frame for which step S403 has not been executed, such as immediately after the first switch SW1 has been turned on, the system control unit 102 sets the arbitrarily selected focus detection point 302 as the main focus detection point if the arbitrarily selected focus detection point 302 has been set in advance. If the arbitrarily selected focus detection point 302 has not been set, the focus detection is performed for all 191 focus detection points 301, and the focus detection point having the focus closest to the camera is taken as the main focus detection point.

In step S405, the system control unit 102 performs automatic exposure computations through a known method using the AE image signal read out in step S401, and determines an aperture value (AV value), a shutter speed (TV value), and an ISO sensitivity (ISO value). Here, the AV value, the TV value, and the ISO value are determined using program diagrams stored in the ROM in advance. Once the system control unit 102 has finished calculating the AV value, the TV value, and the ISO value, the processing moves to step S406.

In step S406, the system control unit 102 detects the state of the second switch SW2; the processing moves to step S407 when the second switch SW2 is on, and to step S408 when the second switch SW2 is off.

In step S407, the system control unit 102 captures an object image. The system control unit 102 adjusts the aperture stop 122 on the basis of the aperture value calculated in step S405, and causes the main mirror 103 and the sub-mirror 104 to flip up and retract from the optical path. Then, the system control unit 102 drives the shutter 110 at a speed based on the shutter speed calculated in step S405, and exposes the image sensor 111. The exposed image sensor 111 generates an image signal and transmits the image signal to the system control unit 102. The system control unit 102 then generates image data from the image signal received from the image sensor 111, stores the image data in the storage unit 202, and displays the image data in the display unit 112, after which the processing moves to step S408.

In step S408, the system control unit 102 detects a predetermined object from the AE image signal read out in step S401, after which the processing moves to step S409. The predetermined object is, for example, typically a person's face or the like, but is not limited thereto. In this case, the system control unit 102 detects a region of the person's face using a known method, and stores parameters such as the position and size of the detected facial region in the RAM.

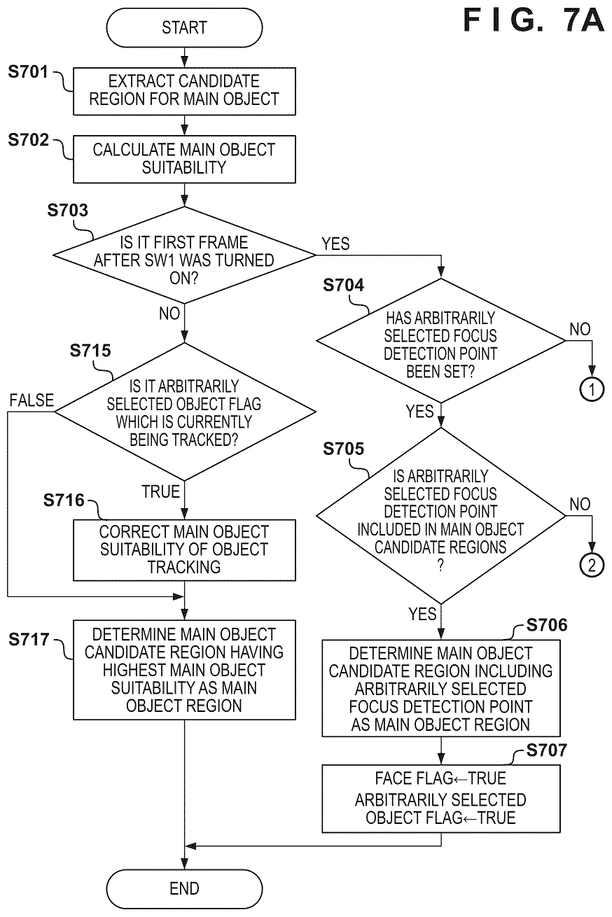

In step S409, the system control unit 102 determines the main object on the basis of the object tracking region 505 detected in step S403 and the facial detection region detected in step S408, the regions having been detected from the AE image signal read out in step S401. If the main object has not been set in a past frame, such as immediately after the first switch SW1 has been turned on, the system control unit 102 determines a new main object region in the AE image signal. However, if the main object has already been set in the past frame, the system control unit 102 determines whether to keep the existing main object or determine an object different from the existing main object as the main object, and then determines the main object region in the AE image signal. The processing moves to step S410 after the main object has been determined. An algorithm for determining the main object will be described later with reference to FIGS. 7A and 7B.

In step S410, the system control unit 102 extracts the main object region determined in step S409 from the AE image signal read out in step S401 and generates a color histogram of the extracted main object region, after which the processing moves to step S411. The generated color histogram is used as a reference color histogram and the tracking AF processing for subsequent frames, as a new target for tracking.

In step S411, the system control unit 102 detects the states of the first switch SW1 and the second switch SW2; if both the switches are on, the system control unit 102 advances the frame by one and moves the processing to step S401, whereas if both switches are off, the system control unit 102 stops the continuous image capturing operations.

The procedure through which the camera 100 according to the present embodiment determines the main object will be described next in detail with reference to FIGS. 7 to 13.

FIGS. 7A and 7B are flowcharts illustrating the main object determination processing performed in step S409. The main object region in the AE image signal is determined, and parameters of the main object region are set, through the processing from steps S701 to S717. The tracking reference data based on the main object region determined in step S409 is generated in step S410, and is used in the tracking AF processing of step S403 performed and subsequent frames.

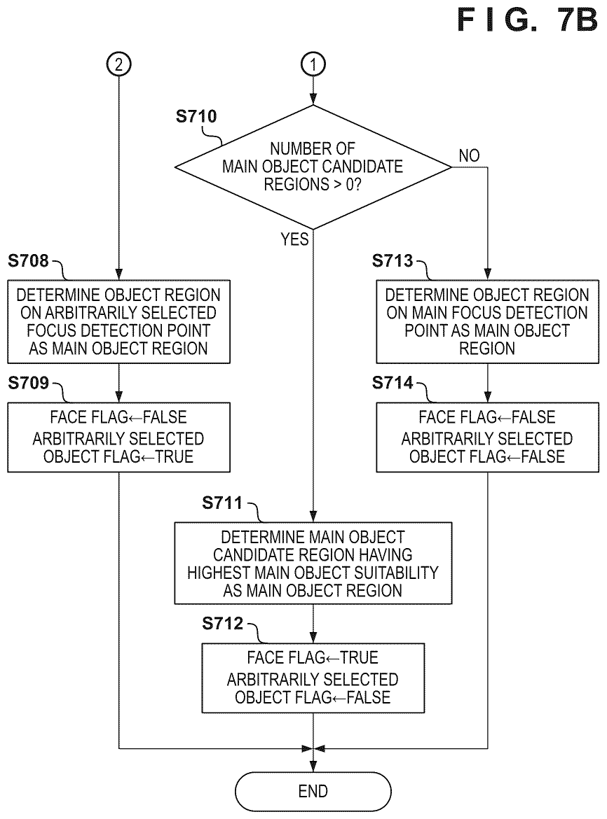

FIG. 8 illustrates an example of the parameters of the main object region. A parameter 801 is a parameter indicating the position of the main object region in the AE image signal, and is constituted by numerical values indicating X and Y coordinates. A parameter 802 is a parameter indicating the size of the main object region in the AE image signal, and is constituted by numerical values indicating a height and a width.

A face flag 803 is set to “true” if the main object region has been determined on the basis of the facial detection region in step S408, and to “false” if not. An arbitrarily selected object flag 804 is set to “true” if the main object region has been determined on the basis of the arbitrarily selected focus detection point 302 set by the user, and to “false” if not, e.g., if the main object region has been determined automatically by the camera or the like. The reason for setting the arbitrarily selected object flag 804 is because the flag is used in processing for determining to change the main object, performed in steps S715 to S717 (described later).

In step S701, the system control unit 102 extracts, from the AE image signal read out in step S401, a candidate region for the main object (“main object candidate region” hereinafter), after which the processing moves to step S702. The object tracking region extracted in step S403 and the facial detection region extracted in step S408 will serve as the main object candidate regions. In the following, a main object candidate region according to the object tracking region will be called a “main object candidate region based on the object tracking region”, whereas a main object candidate region according to the facial detection region will be called a “main object candidate region based on the facial detection region”.

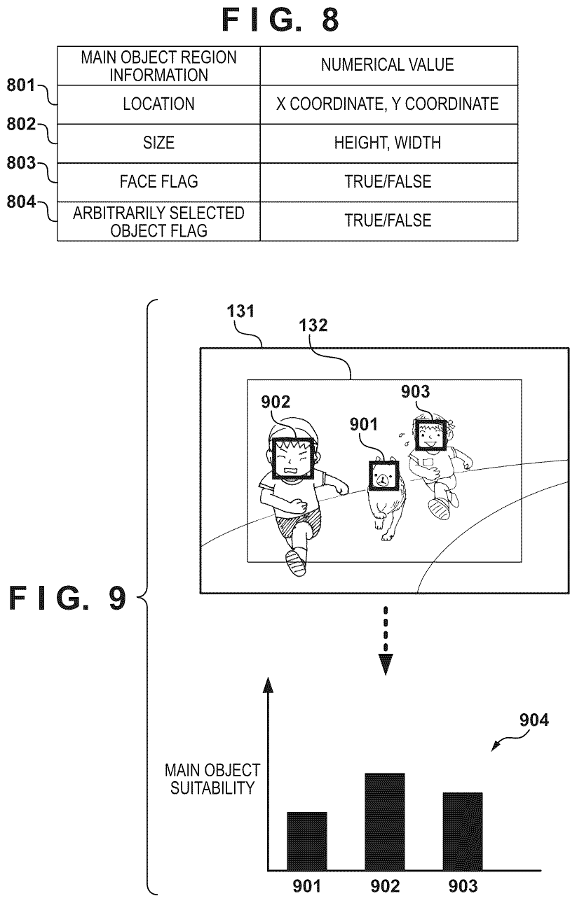

FIG. 9 illustrates an example of an object region serving as a main object candidate region. 901 indicates the object tracking region detected in the tracking AF processing of step S403, which is extracted as the main object candidate region based on the object tracking region. 902 and 903 indicate facial detection regions for people detected through the object detection of step S408, which are extracted as main object candidate regions based on the facial detection region. Thus a total of three regions, i.e., the main object candidate region 901 based on the object tracking region and the main object candidate regions 902 and 903 based on the facial detection region, serve as main object candidate regions. Note that when there is no object tracking region, such as immediately after the first switch SW1 has been turned on, the main object candidate region 901 based on the object tracking region is not extracted.

In step S702, the system control unit 102 calculates a main object suitability for the main object candidate regions extracted in step S701, after which the processing moves to step S703. Formula 1 indicates a formula for calculating the main object suitability.

$$Formula 1$$

$$main object suitability = ( α \times weighting coefficient 1 ) + ( β \times weighting coefficient 2 ) + ( γ \times weighting coefficient 3 )$$

The variable α in Formula 1 is 1 when the main object candidate region is a region corresponding to a person's face, and 0 when the main object candidate region is a region not corresponding to a face. For example, in the example in FIG. 9, a is 1 when calculating the main object candidate regions 902 and 903 based on the facial detection region. Meanwhile, when calculating the main object candidate region 901 based on the object tracking region, the parameters of the main object region currently being tracked are referenced, and α is 1 if the face flag 803 is “true”, and 0 if the face flag 803 is “false”. In the example illustrated in FIG. 9, the main object candidate region 901 based on the object tracking region is not a person's face, and thus α is 0. The variable α is multiplied by a predetermined weighting coefficient 1. The variable α makes it easier for the main object suitability to be higher for an object which is a person's face than for an object which is not a person's face, such as an inanimate object or an animal. This is because when a person is present in an image capturing scene, the main object intended by the user is likely to be the person.

The variable β in Formula 1 is a variable that takes on a higher value the closer the main object candidate region is to the center of the viewfinder screen 131, and a lower value the farther the main object candidate region is from the center of the viewfinder screen 131. Thus in the image capturing scene illustrated in FIG. 9, the variable β increases in the order of the main object candidate region 901 based on the object tracking region, the main object candidate region 903 based on the facial detection region, and the main object candidate region 902 based on the facial detection region. The variable β is multiplied by a predetermined weighting coefficient 2. The variable β makes it easier for the main object suitability to increase the closer an object is to the center of the viewfinder screen 131. This is because a user has a relatively high tendency to capture the main object near the center of the screen when composing a shot.

The variable γ in Formula 1 is a variable that takes on a higher value the closer the main object candidate region is to the camera and a lower value the further the main object candidate region is from the camera. A method in which the focal positions of the focus detection points included in each main object candidate region in the viewfinder screen 131 are detected, and the distance from the camera is estimated on the basis of the focal positions, can be given as an example of a method for finding the distance from the camera to the main object.

In the image capturing scene illustrated in FIG. 9, the variable γ increases in the order of the main object candidate region 902 based on the facial detection region, the main object candidate region 901 based on the object tracking region, and the main object candidate region 903 based on the facial detection region. The variable γ is multiplied by a predetermined weighting coefficient 3. The variable γ makes it easier for the main object suitability to increase the closer an object is to the camera in terms of the image capturing distance. This is because when an object which appears large and an object which appears small are present in the image capturing screen, it is more likely that the object which appears large is the object intended by the user to be the main object.

The weighting coefficients 1, 2, and 3 are adjusted and set in accordance with the purpose of use of the camera, camera settings, and the like. In the present embodiment, the weighting coefficient 1 has the highest weight; the weighting coefficient 3, the next-highest weight; and the weighting coefficient 2, the lowest weight.

A graph 904 indicates the results of calculating the main object suitability for the main object candidate region 901 based on the object tracking region, the main object candidate region 902 based on the facial detection region, and the main object candidate region 903 based on the facial detection region. In the graph 904, the main object suitabilities of the main object candidate region 902 based on the facial detection region and the main object candidate region 903 based on the facial detection region are higher than that of the main object candidate region 901 based on the object tracking region due to the effect of the weighting coefficient 1, which is the greatest. Furthermore, the main object suitability of the main object candidate region 902 based on the facial detection region is higher than that of the main object candidate region 903 based on the facial detection region due to the effect of the weighting coefficient 3, which is next-greatest.

In step S703, the system control unit 102 determines whether the current frame is the first frame after the first switch SW1 was turned on; the processing moves to step S704 if the frame is the first frame, and to step S715 if the frame is not the first frame.

If, in step S704, the arbitrarily selected focus detection point 302 had been set before the first switch SW1 was turned on, the system control unit 102 moves the processing to step S705, and if the arbitrarily selected focus detection point 302 had not been set, the system control unit 102 moves the processing to step S710.

The processing of steps S705 to S709 described next is processing for determining the main object region when the user has already set the arbitrarily selected focus detection point 302 in the first frame after the first switch SW1 was turned on. In the first frame after the first switch SW1 was turned on, no tracking target has been set, and thus no main object candidate region based on the object tracking region is present.

In step S705, the system control unit 102 compares the positions of all the main object candidate regions extracted in step S701 with the position of the arbitrarily selected focus detection point 302. If the arbitrarily selected focus detection point 302 is present within any of the main object candidate regions, the processing moves to step S706. Additionally, if not even one facial region is detected in step S408, and there is therefore no main object candidate region, or if the arbitrarily selected focus detection point 302 is not present within any of the main object candidate regions, the processing moves to step S708.

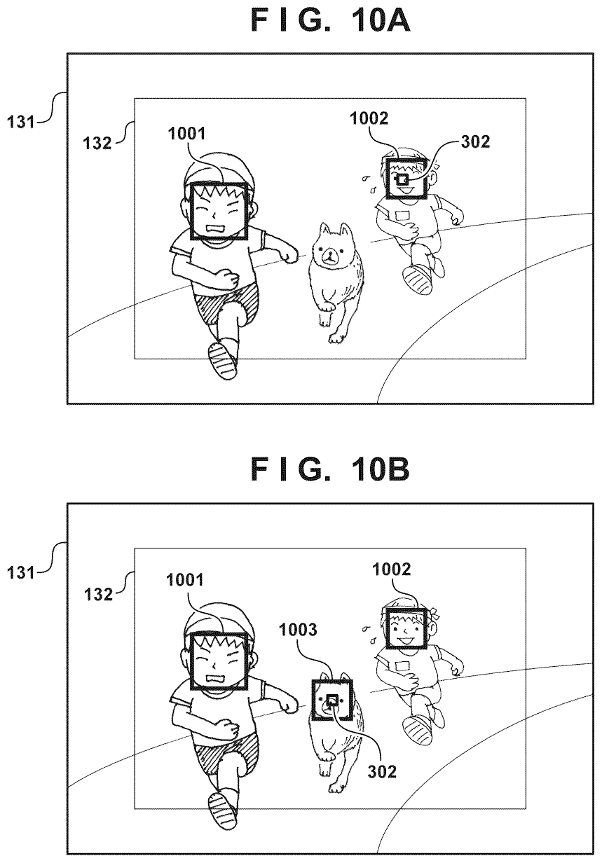

FIG. 10A illustrates an example in which the arbitrarily selected focus detection point 302 is present within a main object candidate region. 1001 and 1002 indicate main object candidate regions based on a facial detection region for a person, detected in step S408.

In step S706, of the main object candidate regions 1001 and 1002, the system control unit 102 determines the main object candidate region 1002, which includes the arbitrarily selected focus detection point 302, as the main object region. The system control unit 102 then sets the position of the determined main object region as the parameter 801 and the size as the parameter 802, after which the processing moves to step S707.

In step S707, the main object region determined in step S706 is a main object candidate region based on a facial detection region, and the system control unit 102 therefore sets the face flag 803 to “true”. Additionally, the main object region includes the arbitrarily selected focus detection point 302, and the arbitrarily selected object flag 804 is therefore also set to “true”. The system control unit 102 then ends the main object determination processing.

FIG. 10B illustrates an example in which the arbitrarily selected focus detection point 302 is not present within a main object candidate region.

In step S708, the system control unit 102 determines, as a main object region 1003, a region, having a predetermined size, which is centered on the location of the arbitrarily selected focus detection point 302. The system control unit 102 then sets the position of the determined main object region as the parameter 801 and the size as the parameter 802, after which the processing moves to step S709.

Note that a method for detecting a specific object, such as a known object detection or animal detection method, may be used to set a detected object region which includes the arbitrarily selected focus detection point 302 as the main object region.

In step S709, the main object region determined in step S708 is not a main object candidate region based on a facial detection region, and the system control unit 102 therefore sets the face flag 803 to “false”. However, because the object has been determined on the basis of the arbitrarily selected focus detection point 302, the system control unit 102 sets the arbitrarily selected object flag 804 to “true”. The system control unit 102 then ends the main object determination processing.

Through the above-described processing of steps S704 to S709, if the arbitrarily selected focus detection point 302 has been set by the user, the main object is always determined on the basis of the arbitrarily selected focus detection point 302 in a frame immediately after the first switch SW1 has been turned on. This is because in a situation where the user has intentionally set the arbitrarily selected focus detection point 302, it is highly likely that the main object intended by the user is present at the arbitrarily selected focus detection point 302.

The processing of steps S710 to S714 described next is processing for determining the main object region when the user has not set the arbitrarily selected focus detection point 302 in the first frame after the first switch SW1 was turned on. In the first frame after the first switch SW1 was turned on, no tracking target has been set, and thus no main object candidate region based on the object tracking region is present.

In step S710, the system control unit 102 moves the processing to step S711 if the number of main object candidate regions extracted in step S701 is greater than or equal to 1, and to step S713 if that number is 0.

In step S711, the system control unit 102 determines the main object candidate region which has the highest main object suitability calculated in step S702 among all the main object candidate regions as the main object region. The system control unit 102 then sets the position of the determined main object region as the parameter 801 and the size as the parameter 802, after which the processing moves to step S712.

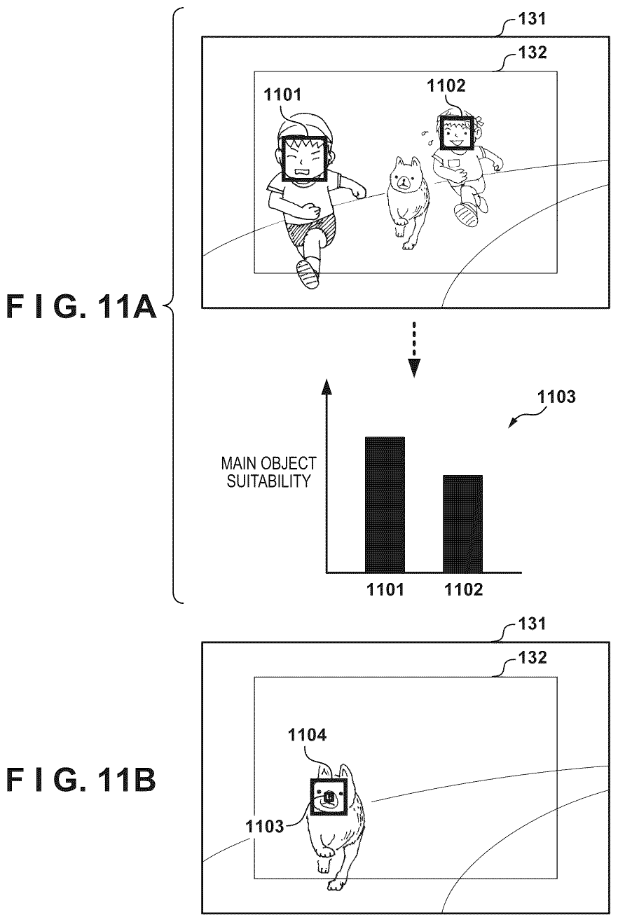

FIG. 11A illustrates an example of the main object region set in step S711. 1101 and 1102 are regions extracted as main object candidate regions based on a facial detection region in step S701. 1103 is a graph, calculated in step S702, representing the main object suitabilities of the main object candidate regions 1101 and 1102 based on facial detection regions. In this image capturing scene, the main object candidate region 1101 based on the facial detection region is determined as the main object region. Note that step S711 is a process executed only in the first frame after the first switch SW1 was turned on, and thus no main object candidate region based on the object tracking region is present.

In step S712, the main object region determined in step S711 is a main object candidate region based on a facial detection region, and the system control unit 102 therefore sets the face flag 803 to “true”. Additionally, because the arbitrarily selected focus detection point 302 is not set, the system control unit 102 sets the arbitrarily selected object flag 804 to “false”. The system control unit 102 then ends the main object determination processing.

In step S713, the system control unit 102 determines, as the main object region, a region, having a predetermined size, which is centered on the location of the main focus detection point determined in step S404. The system control unit 102 then sets the position of the determined main object region as the parameter 801 and the size as the parameter 802, after which the processing moves to step S714.

Note that a method for detecting a specific object, such as a known object detection or animal detection method, may be used to set the main focus detection point determined in step S404 as the main object region.

FIG. 11B illustrates an example of the main object region set in step S713. A main focus detection point 1103 is the main focus detection point selected in the focus adjustment processing of step S404. As described above, in step S404, if the current frame is the first frame after the first switch SW1 was turned on and the arbitrarily selected focus detection point 302 has not been set, the point, of the 191 focus detection points, which has a focal point located closest to the camera is selected as the main focus detection point.

A main object region 1104 is set as a region, having a predetermined size, which is centered on the location of the main focus detection point 1103.

In step S714, the main object region determined in step S713 is not a main object candidate region based on a facial detection region, and the system control unit 102 therefore sets the face flag 803 to “false”. Additionally, because the arbitrarily selected focus detection point 302 is not set, the arbitrarily selected object flag 804 is also set to “false”. The system control unit 102 then ends the main object determination processing.

In step S715, the system control unit 102 refers to the arbitrarily selected object flag 804 of the main object region which is currently set, and moves the processing to step S716 if the flag is “true”, and to step S717 if the flag is “false”.

In step S716, the system control unit 102 applies predetermined correction to the main object suitability of the main object candidate region, among the main object candidate regions extracted in step S701, which is based on the object tracking region, after which the processing moves to step S717.

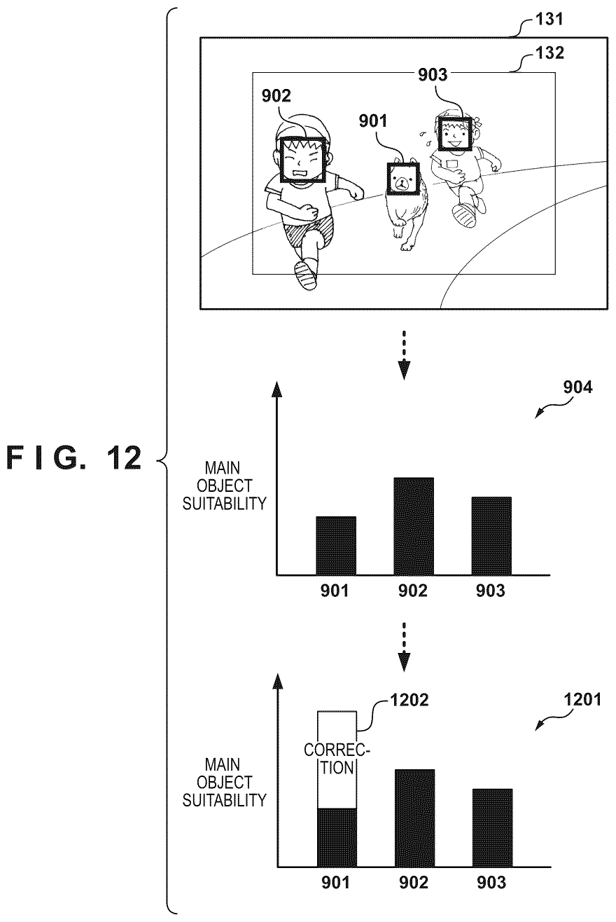

FIG. 12 illustrates an example of the image capturing scene illustrated in FIG. 9 and a graph representing the main object suitability of each main object candidate region, as well as a result of applying the predetermined correction to the main object suitability of the main object candidate region based on the object tracking region. A graph 1201 indicates a result of applying predetermined correction 1202 to the main object suitability of the main object candidate region 901 based on the object tracking region, in the graph 904 of the main object suitability in the image capturing scene illustrated in FIG. 9. As a result of correction 1202, the main object suitability of the main object candidate region 901 based on the object tracking region becomes higher than those of the other main object candidate regions 902 and 903. Accordingly, in step S717 (described later), the main object candidate region 901 based on the object tracking region is determined as the main object region.

Note that the magnitude of the correction 1202 may, for example, be such that the user can set the aggressiveness of object changes as a camera setting, with a lower degree of correction used when the aggressiveness of object changes is set higher, and a higher degree of correction used when the aggressiveness of object changes is set lower. Alternatively, the magnitude of the correction 1202 may be a predetermined fixed value. Note that the correction 1202 may be in a format which is added as offset, or in a format which is multiplied as gain. Furthermore, the magnitude of the correction 1202 may be reduced in accordance with the length of time which has elapsed since the first switch SW1 was turned on. This is done so that when a sufficient length of time has elapsed after the first switch SW1 was turned on, even if the main object is determined on the basis of a main object suitability for which the effect of the correction 1202 has been reduced, the usability can be improved while also ensuring there is little drop in the consistency with the user's intent.

This correction is applied because an main object arbitrarily selected by the user has a higher priority as the main object over other objects. For example, in the image capturing scene illustrated in FIG. 9, if the main object candidate region 901 based on the object tracking region is the object arbitrarily selected by the user, it is highly likely that the main object intended by the user will be in the region 901 in subsequent frames as well. Accordingly, when the main object being tracked is an object which has been arbitrarily selected by the user, applying the predetermined correction to the main object suitability of the main object candidate region based on the object tracking region suppresses situations where the main object is changed to another object contrary to the user's intentions.

However, if, for example, the main object has moved away from the camera or the like and the suitability thereof as a main object has dropped as a result, and another object having an extremely high main object suitability has appeared, changing the main object to that other object can be considered consistent with the user's intent. Accordingly, if another object having a main object suitability higher than the main object currently being tracked is present, the main object is changed from the current main object to that other object, even if the correction 1202 is taken into account. Through this, when another object which is significantly more suitable as the main object than the current main object has appeared due to, for example, a change in the image capturing scene being continuously captured, the main object can be changed to that other object, which makes it possible to implement a main object change consistent with the user's intentions.

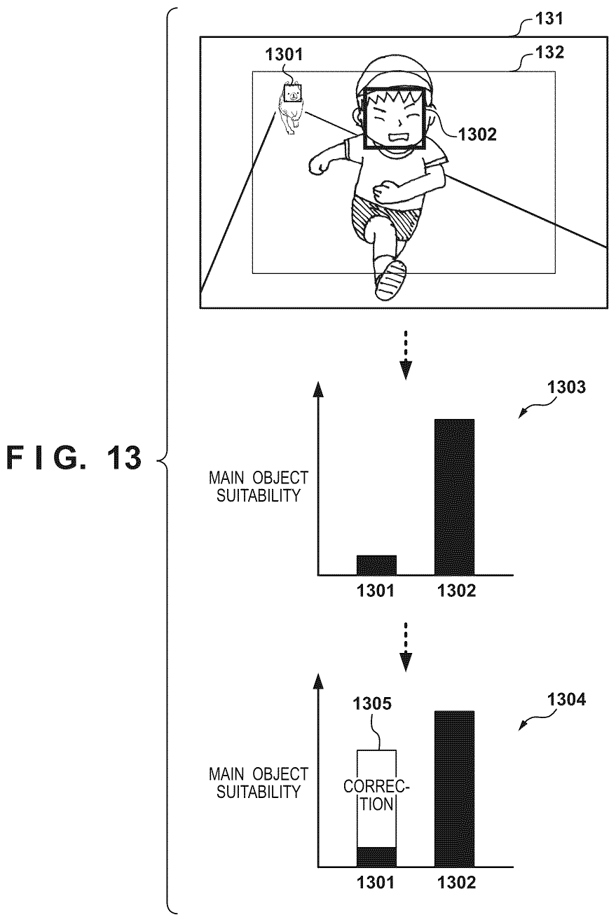

FIG. 13 illustrates an example in which the main object is changed. 1301 indicates a main object candidate region based on the object tracking region, which was set in a past frame on the basis of the desired selected focus detection point 302 set by the user. 1302 indicates a main object candidate region based on the facial detection region.

A graph 1303 is a graph representing the result of calculating the main object suitabilities for the main object candidate region 1301 based on the object tracking region and the main object candidate region 1302 based on the facial detection region in step S702. A graph 1304 indicates the result of applying correction 1305 to the main object suitability of the main object candidate region 1301 based on the object tracking region.

In the graph 1303, the object in the main object candidate region 1301 based on the object tracking region is far from the camera and is also far from the center of the viewfinder screen 131, and therefore has a low main object suitability. On the other hand, the object in the main object candidate region 1302 based on the facial detection region is close to the camera and is also near the center of the viewfinder screen 131, and therefore has a high main object suitability.

Thus as indicated by the graph 1304, the main object candidate region 1302 based on the facial detection region has a higher main object suitability than the main object candidate region 1301 based on the object tracking region even when the correction 1305 is applied.

Accordingly, in the example of FIG. 13, in step S717 (described later), the main object candidate region 1302 based on the facial detection region is determined as the main object region.

Thus when tracking a main object arbitrarily selected by the user while performing continuous capturing in the tracking AF mode, the correction described above suppresses changing of the main object on the basis of a predetermined condition, which makes it possible to determine to change the main object in a manner consistent with the user's intentions.

In step S717, the system control unit 102 determines the region having the highest main object suitability among all the main object candidate regions as the main object region, sets new parameters for the main object region, and then ends the main object determination processing.

In terms of setting the face flag 803 and the arbitrarily selected object flag 804, different parameters are set depending on whether or not the main object has changed. That is, when the determined main object region is a main object candidate region based on the object tracking region, the main object which had been tracked up to the current frame will continue to be tracked in subsequent frames, and thus the main object will remain unchanged. In this case, the face flag 803 and the arbitrarily selected object flag 804 are inherited from the parameters of the main object region in the frame immediately previous.

On the other hand, when the main object region determined here is a main object candidate region based on the facial detection region, an object different from the main object which had been tracked up to the current frame will be tracked in subsequent frames, which means that the main object has changed. In this case, the face flag 803 is set to “true” and the arbitrarily selected object flag 804 is set to “false”.

Note that when the main object has changed, if the original main object from before the change remains present in the AE image signal in subsequent frames, the correction may continue to be applied to the main object suitability of the original main object, or the correction may not be applied.

Because the original main object is an object arbitrarily selected by the user, it is desirable that the correction continue to be applied to the original main object in subsequent frames if the original main object is to be prioritized as the main object. Continuing to apply the correction makes it easier for the original main object, which was arbitrarily selected by the user, to be selected as the main object in subsequent frames as well.

On the other hand, because the main object after the change is an object having a higher main object suitability than the object arbitrarily selected by the user even after applying the correction, it is desirable that the correction not be applied to the original main object in subsequent frames when the post-change main object is to be prioritized as the main object. This makes it possible to suppress situations where the main object is again changed back to the original main object.

According to the main object determination processing of the first embodiment, when a main object to be tracked has been arbitrarily selected by a user, the suitability of a candidate object, among the candidate objects, that is the same as the object as the object currently being tracked is corrected so as to suppress a change in the object being tracked. Through this, main object selections and main object changes which are consistent with the user's intentions can be realized even during continuous capturing in a tracking AF mode.

### Second Embodiment

A second embodiment will be described next.

The second embodiment will describe a method which changes a main object in a manner consistent with a user's intentions by suppressing a change in a main object arbitrarily selected by the user while that main object is being tracked, through a method different from that used in the first embodiment. To summarize, the second embodiment describes an example in which when determining whether to change the main object, only main object candidates having a main object suitability greater than or equal to a predetermined threshold are subject to the main object change.

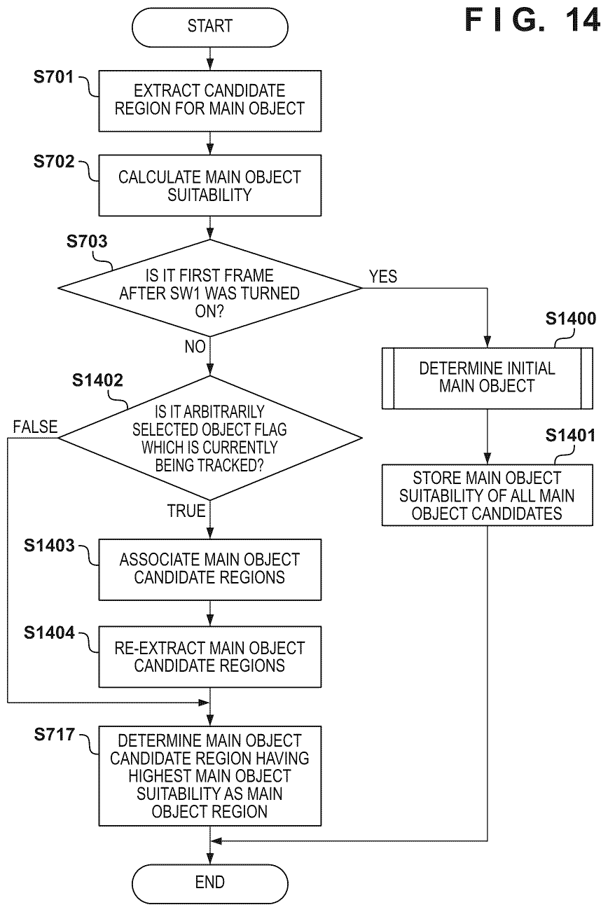

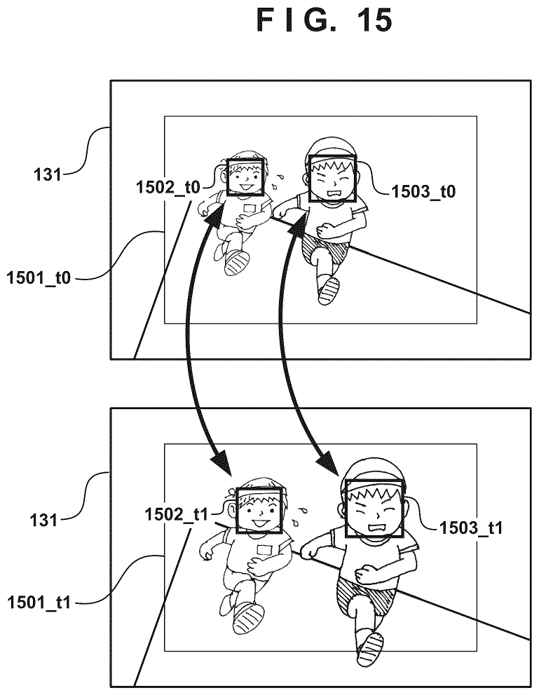

The second embodiment differs from the first embodiment only in terms of the algorithm for the main object determination performed in step S409, and the other configurations are the same. As such, the algorithm for the main object determination performed in step S409 according to the present embodiment will be described next with reference to FIGS. 14 and 15.

FIG. 14 is a flowchart illustrating the main object determination processing performed in step S409 according to the second embodiment. The processing illustrated in FIG. 14 is based on the main object determination processing described in the first embodiment with reference to FIGS. 7A and 7B, and differs in that step S1401 has been added, and that steps S715 and S716 have been replaced with steps S1402 and S1404, respectively. Because the other steps are the same, the processing from steps S704 to S714 will be treated as the initial main object determination processing of step S1400, and will therefore not be described.

The processing from steps S1401 to S1404 will be described hereinafter.

In step S1401, as processing performed after the initial main object determination of step S1400, the system control unit 102 stores information of all the main object candidate regions for that frame, and ends the main object determination processing. Specifically, the position and size of each region, and the main object suitability calculated in step S702, are stored in the RAM for all of the main object candidate regions extracted in step S701. The information stored here is used in steps S1403 and S1404 for subsequent frames, as the main object candidate regions of an initial frame. Note that the “initial frame” is the first frame after the first switch SW1 was turned on, and step S1401 is executed only for the initial frame after the processing branches from step S703.

In step S1402, the system control unit 102 refers to the arbitrarily selected object flag 804 of the main object region which is currently set, and moves the processing to step S1403 if the flag is “true”, and to step S717 if the flag is “false”. As a result of this determination, the re-extraction of the main object candidate regions in the subsequent processing of steps S1403 to S1404 is only performed when the object currently being tracked is an object which has been arbitrarily selected by the user.

Processing for associating the main object candidate region, performed in step S1403, will be described next with reference to FIG. 15.

An AE image signal 1501_t0 is the AE image signal of the initial frame, and an AE image signal 1501_t1 is an AE image signal of the current frame. Main object candidate regions 1502_t0 and 1503_t0 are main object candidate regions based on the facial detection region, both of which have been extracted from the initial frame. Of these, 1502_t0 is a region determined to be a main object region on the basis of the arbitrarily selected focus detection point 302 set by the user, and is a region to be tracked in subsequent frames. A main object candidate region 1502_t1 is a main object candidate region based on object tracking, extracted from the current frame. A main object candidate region 1503_t1 is a main object candidate region based on the facial detection region, extracted from the current frame.

In step S1403, the system control unit 102 first reads out, from the RAM, the information on the positions, sizes, and main object suitabilities of the main object candidate regions 1502_t0 and 1503_t0 in the initial frame, stored in step S1401.

Next, regions which correspond to the same object between the main object candidate regions 1502_t0 and 1503_t0 of the initial frame, which have been read out, and the main object candidate regions 1502_t1 and 1503_t1, which have been extracted from the current frame, are associated with each other. A method in which all possible combinations of region positions and sizes are compared between all the main object candidate regions in the initial frame and all the main object candidate regions in the current frame, and regions for which the differences between the positions and sizes are less than or equal to a predetermined value are associated with each other, can be given as an example of the method for performing this association. Alternatively, information pertaining to the organs of the face, such as the eyes and the nose, which characterizes individuals, including the positions, sizes, and shapes of those organs, may be stored separately, and the association may then be performed through a known individual recognition technique which uses such facial organ information.

In the state illustrated in FIG. 15, of the main object candidate regions, 1502_t0 and 1502_t1 are associated with each other, and 1503_t0 and 1503_t1 are associated with each other, as a result of this association process.

Finally, of the parameters of the main object candidate regions 1502_t0 and 1503_t0 in the initial frame, the system control unit 102 updates the positions and sizes to the positions and sizes of the main object candidate regions 1502_t1 and 1503_t1 in the current frame, which are associated therewith. However, of the parameters of the main object candidate region, only the main object suitabilities are not updated. Once the overall update processing ends, the processing moves to step S1404.

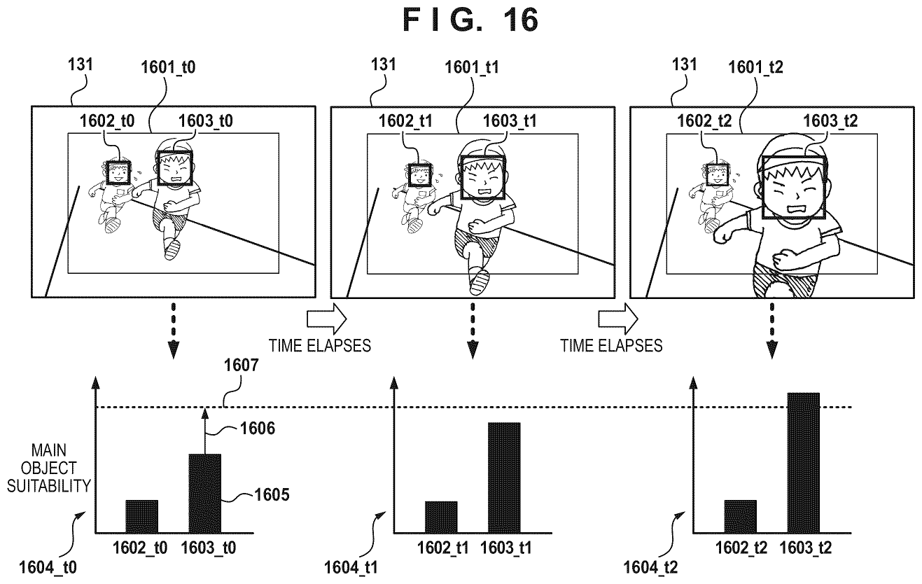

Processing for re-extracting the main object region, performed in step S1404, will be described next with reference to FIG. 16.

An AE image signal 1601_t0 is the AE image signal of the initial frame. Main object candidate regions 1602_t0 and 1603_t0 are main object candidate regions based on the facial detection region, both of which have been extracted from the initial frame. 1602_t0 is a region determined to be a main object region on the basis of the arbitrarily selected focus detection point 302 set by the user, and is a region to be tracked in subsequent frames. A graph 1604_t0 represents a result of calculating the main object suitabilities for the two main object candidate regions 1602_t0 and 1603_t0.

An AE image signal 1601_t1 is the AE image signal of a frame after a predetermined length of time has elapsed following the initial frame. A main object candidate region 1602_t1 is a main object candidate region based on object tracking, extracted from the frame of the AE image signal 1601_t1. The main object candidate region 1602_t1 based on object tracking is associated with the main object candidate region 1602_t0 of the initial frame through the processing performed in step S1403. A main object candidate region 1603_t1 is a main object candidate region based on the facial detection region, extracted from the frame of the AE image signal 1601_t1. The main object candidate region 1603_t1 based on the facial detection region is associated with the main object candidate region 1603_t0 of the initial frame through the processing performed in step S1403. A graph 1604_t1 represents a result of calculating the main object suitabilities for these two main object candidate regions 1602_t1 and 1603_t1.

An AE image signal 1601_t2 is the AE image signal from a frame after a predetermined length of time has elapsed following the frame of the AE image signal 1601_t1. A main object candidate region 1602_t2 is a main object candidate region based on object tracking, extracted from the frame of the AE image signal 1601_t2. The main object candidate region 1602_t2 based on object tracking is associated with the main object candidate region 1602_t1 of a past frame through the processing performed in step S1403. A main object candidate region 1603_t2 is a main object candidate region based on the facial detection region, extracted from the frame of the AE image signal 1601_t2. The main object candidate region 1603_t2 based on the facial detection region is associated with the main object candidate region 1603_t1 of a past frame through the processing performed in step S1403. A graph 1604_t2 represents a result of calculating the main object suitabilities for these two main object candidate regions 1602_t2 and 1603_t2.

In step S1404, the system control unit 102 first obtains a main object suitability value 1605 of the main object candidate region 1603_t0 which, of the main object candidate region 1602_t0 and the main object candidate region 1603_t0 of the initial frame, has the highest main object suitability. A value obtained by adding together the main object suitability value 1605 and a predetermined main object suitability offset 1606 is then set as a main object re-extraction threshold 1607. The main object suitability offset 1606 is set, for example, such that the user can set the aggressiveness of object changes as a camera setting, with a lower offset used when the aggressiveness of object changes is set higher, and a higher offset used when the aggressiveness of object changes is set lower. Alternatively, the main object suitability offset 1606 may be a predetermined fixed value.

Next, the system control unit 102 further extracts, from the main object candidate regions extracted from the current frame in step S701, only a main object candidate region which satisfies a predetermined condition. The “predetermined condition” is that the region is a main object candidate region based on object tracking, or is a main object candidate region having a main object suitability greater than or equal to the main object re-extraction threshold 1607.

For example, in the frame of the AE image signal 1601_t1, the main object candidate region 1602_t1 based on object tracking is extracted. However, the main object candidate region 1603_t1 based on the facial detection region is, as indicated by the graph 1604_t1, below the main object re-extraction threshold 1607, and is therefore not extracted.

On the other hand, in the frame of the AE image signal 1601_t2, the main object candidate region 1602_t2 based on object tracking is extracted.

Additionally, the main object candidate region 1603_t2 based on the facial detection region is, as indicated by the graph 1604_t2, above the main object re-extraction threshold 1607, and is therefore extracted.

The processing moves to step S717 once the re-extraction of the main object candidate region is complete.

In step S717, if step S1404 has been performed, only the re-extracted main object candidate region is subject to the main object region selection.

For example, in the frame of the AE image signal 1601_t1, only the main object candidate region 1602_t1 is subject to the main object region selection, and the main object is therefore not changed.

On the other hand, in the frame of the AE image signal 1601_t2, the main object candidate regions 1602_t2 and 1603_t2 are subject to the main object region selection, and because the main object candidate region 1603_t2 has the higher main object suitability, the main object candidate region 1603_t2 is determined as the main object region. As a result, the main object is changed from the main object candidate region 1603_t2 to the main object candidate region 1603_t2, and the new main object candidate region 1603_t2 is then tracked in the subsequent frames.

In the second embodiment, when the main object to be tracked is an object arbitrarily selected by the user, the main object is not changed until the main object suitability of one of the main object candidates in a subsequent frame becomes greater than or equal to a predetermined threshold. The predetermined threshold is set higher than the main object suitabilities of all the main object candidates in the initial frame, and the main object is therefore not changed until a main object having a higher suitability than in the initial frame appears.

This makes it possible to suppress situations where the main object is needlessly changed from a main object arbitrarily selected by the user, and makes it possible to implement main object selections and main object changes consistent with the user's intentions. This is because at least in the initial frame, an object arbitrarily selected by the user will be the main object most consistent with the user's intentions precisely because it has been selected by the user, and if the image capturing scene, the composition, and so on change little in the subsequent frames, not changing the main object will ensure consistency with the user's intentions. On the other hand, if in subsequent frames the image capturing scene, the composition, or the like has changed drastically from the initial frame, changing the main object to an optimal object on the basis of the image capturing scene is more convenient for the user.

As an additional condition for the re-extraction performed in step S1404, it is possible to have the re-extraction performed only when a difference between the main object suitability of a main object candidate region based on object tracking and the main object suitability of other main object candidate regions is greater than the same difference at the time of the initial frame. Through this, even if the main object suitability of a main object candidate region aside from the main object region has exceeded the main object re-extraction threshold 1607, a change in the main object can be suppressed as long as the main object suitability of the main object region is similarly high.

According to the main object determination processing of the second embodiment, when a main object to be tracked has been arbitrarily selected by a user, the suitability of a candidate object, among the candidate objects, that is the same as the object as the object currently being tracked is corrected so as to suppress a change in the object being tracked. Through this, main object selections and main object changes which are consistent with the user's intentions can be realized even during continuous capturing in a tracking AF mode.

### Third Embodiment

A third embodiment will be described next.

The third embodiment will describe a method which changes a main object in a manner consistent with a user's intentions by suppressing a change in a main object arbitrarily selected by the user while that main object is being tracked, through a method different from that used in the first and second embodiments. To summarize, the third embodiment describes an example in which when determining whether to change the main object, the main object is re-selected only when the main object suitability of the object currently being tracked has dropped below a predetermined threshold.

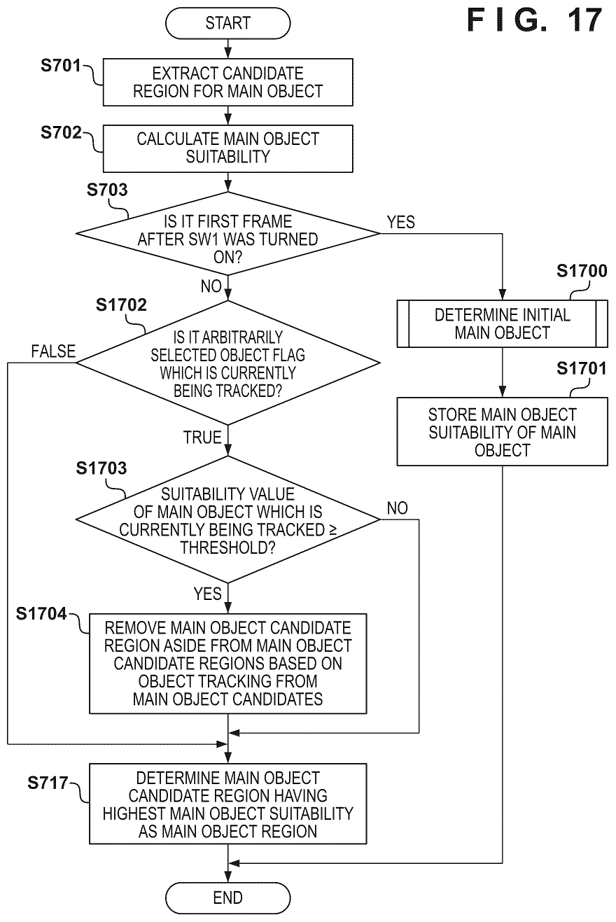

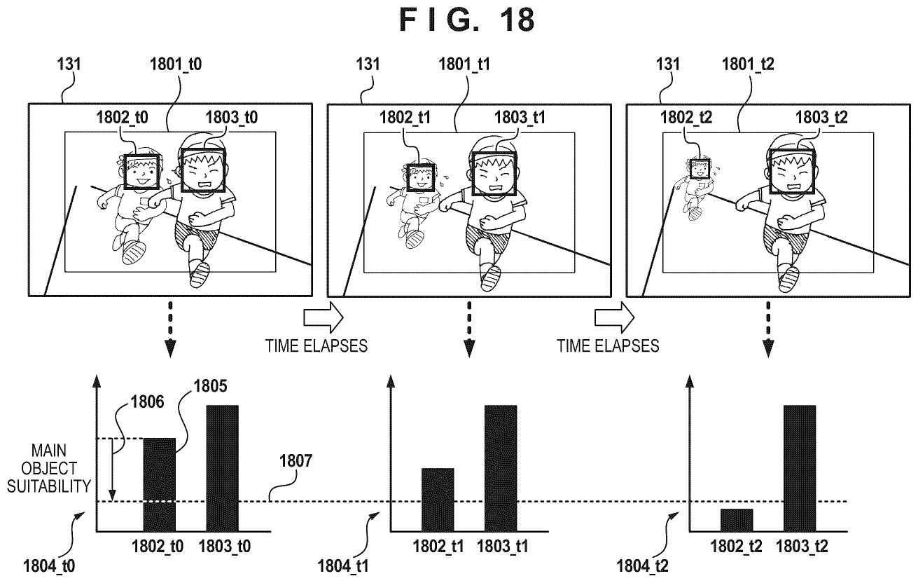

The third embodiment differs from the first embodiment only in terms of the algorithm for the main object determination performed in step S409, and the other configurations are the same. As such, the algorithm for the main object determination performed in step S409 according to the present embodiment will be described next with reference to FIGS. 17 and 18.

FIG. 17 is a flowchart illustrating the main object determination processing performed in step S409 according to the third embodiment. The processing illustrated in FIG. 17 is based on the main object determination processing described in the first embodiment with reference to FIGS. 7A and 7B, and differs in that step S1701 has been added, and that steps S715 and S716 have been replaced with steps S1702 and S1704, respectively. Because the other steps are the same, the processing from steps S704 to S714 will be treated as the initial main object determination processing of step S1700, and will therefore not be described.

FIG. 18 illustrates an example of a determination standard for changing the main object according to the third embodiment. An AE image signal 1801_t0 is the AE image signal of the initial frame. Main object candidate regions 1802_t0 and 1803_t0 are main object candidate regions based on the facial detection region, both of which have been extracted from the initial frame. Of these, 1802_t0 is a region determined to be a main object region on the basis of the arbitrarily selected focus detection point 302 set by the user, and is a region to be tracked in subsequent frames. A graph 1804_t0 represents a result of calculating the main object suitabilities for these two main object candidate regions 1802_t0 and 1803_t0.

An AE image signal 1801_t1 is the AE image signal of a frame after a predetermined length of time has elapsed following the initial frame. A main object candidate region 1802_t1 is a main object candidate region based on object tracking, extracted from the frame of the AE image signal 1801_t1. A main object candidate region 1803_t1 is a main object candidate region based on the facial detection region, extracted from the frame of the AE image signal 1801_t1. A graph 1804_t1 represents a result of calculating the main object suitabilities for these two main object candidate regions 1802_t1 and 1803_t1.

An AE image signal 1801_t2 is the AE image signal from a frame after a predetermined length of time has elapsed following the frame of the AE image signal 1801_t1. A main object candidate region 1802_t2 is a main object candidate region based on object tracking, extracted from the frame of the AE image signal 1801_t2. A main object candidate region 1803_t2 is a main object candidate region based on the facial detection region, extracted from the frame of the AE image signal 1801_t2. A graph 1804_t2 represents a result of calculating the main object suitabilities for these two main object candidate regions 1802_t2 and 1803_t2.

The processing from steps S1701 to S1704 will be described hereinafter.

After determining the initial main object region in step S1700, in step S1701, the system control unit 102 stores the main object suitability of the main object region 1802_t0 from the initial frame in the RAM of the system control unit 102 as a reference main object suitability value 1805. The information stored here is used in step S1703 for subsequent frames. Once the reference main object suitability value 1805 has been stored, the system control unit 102 ends the main object determination processing.

In step S1702, the system control unit 102 refers to the arbitrarily selected object flag 804 of the main object region which is currently set, and moves the processing to step S1703 if the flag is “true”, and to step S717 if the flag is “false”. As a result of this determination, the processing of the subsequent steps S1703 to S1704 is only executed when the object currently being tracked is an object which has been arbitrarily selected by the user.

In step S1703, the system control unit 102 first reads out the reference main object suitability value 1805 from the RAM. Then, a value obtained by subtracting a predetermined main object suitability offset 1806 from the reference main object suitability value 1805 is set as a main object re-selection threshold 1807. The main object suitability offset 1806 is set, for example, such that the user can set the aggressiveness of object changes as a camera setting, with a lower offset used when the aggressiveness of object changes is set higher, and a higher offset used when the aggressiveness of object changes is set lower. Alternatively, the main object suitability offset 1806 may be a predetermined fixed value.

Next, the system control unit 102 moves the processing to step S1704 if the main object suitability of the main object candidate region based on object tracking in the current frame is greater than or equal to the main object re-selection threshold 1807, and to step S717 if the main object suitability is less than the main object re-selection threshold 1807.

For example, as indicated by the graph 1804_t1, in the frame of the AE image signal 1801_t1, the main object suitability of the main object candidate region 1802_t1 based on object tracking is greater than or equal to the main object re-selection threshold 1807, and the processing therefore moves to step S1704.

On the other hand, as indicated by the graph 1804_t2, in the frame of the AE image signal 1801_t2, the main object suitability of the main object candidate region 1802_t2 based on object tracking is less than the main object re-selection threshold 1807, and the processing therefore moves to step S717.

In step S1704, of the main object candidate regions extracted from the current frame in step S701, the system control unit 102 removes the main object candidate regions aside from the main object candidate regions based on object tracking from the main object candidates, after which the processing moves to step S717.

For example, in the frame of the AE image signal 1801_t1, the main object candidate region 1803_t1 based on the facial detection region is removed from the main object candidate. As a result, only the main object candidate region 1802_t1 based on object tracking is the main object candidate region used in the selection of the main object region in step S717, and the main object is therefore not changed.

On the other hand, when step S1704 is not performed, as is the case with the frame of the AE image signal 1801_t2, the main object candidate regions are not removed. As a result, all of the main object candidate regions extracted in step S701 are subject to the main object region selection in step S717, and thus the main object may change depending on the main object suitabilities of those main object candidate regions.

In the third embodiment, when the main object to be tracked is an object arbitrarily selected by the user, the main object is not changed until the main object suitability of the main object to be tracked drops below a predetermined threshold in a subsequent frame. The predetermined threshold is set lower than the main object suitability of the main object in the initial frame, and thus the main object will not change as long as the main object suitability of the main object does not drop below that of the initial frame by a certain amount. This makes it possible to suppress situations where the main object is needlessly changed from a main object arbitrarily selected by the user, and makes it possible to implement main object selections and main object changes consistent with the user's intentions. The reason for this is that first, at least in the initial frame, an object arbitrarily selected by the user will be the main object most consistent with the user's intentions precisely because it has been selected by the user, and an object arbitrarily selected by the user therefore satisfies the requirements for a main object regardless of how high or low the main object suitability is. The main object should therefore not be changed easily, even if there is another object having a high main object suitability.

On the other hand, if, as with the AE image signal 1801_t2, the main object suitability of the object arbitrarily selected by the user drops drastically and no longer satisfies the requirements for a main object, changing the main object in accordance with the circumstances is more convenient for the user.

According to the main object determination processing of the third embodiment, when the main object to be tracked has been arbitrarily selected by the user, changes in the object being tracked are suppressed until the suitability of the object currently being tracked drops below a predetermined threshold. Through this, main object selections and main object changes which are consistent with the user's intentions can be realized even during continuous capturing in a tracking AF mode.

### Fourth Embodiment

A fourth embodiment will be described hereinafter.

The fourth embodiment will describe a method which changes a main object in a manner consistent with a user's intentions by suppressing a change in a main object arbitrarily selected by the user while that main object is being tracked, through a method different from that used in the first to third embodiments. To summarize, the fourth embodiment describes an example in which when the user has arbitrarily selected a main object at the point in time when the first switch SW1 turns on, the main object is prohibited from being changed for a predetermined period from that point in time.

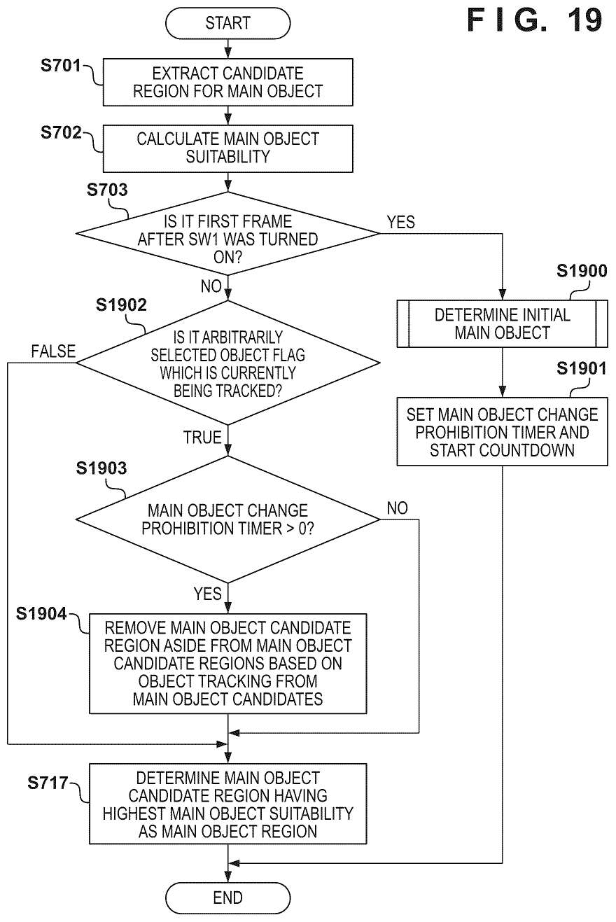

The fourth embodiment differs from the first embodiment only in terms of the algorithm for the main object determination performed in step S409, and the other configurations are the same. As such, the algorithm for the main object determination performed in step S409 according to the present embodiment will be described next with reference to FIG. 19.

FIG. 19 is a flowchart illustrating the main object determination processing performed in step S409 according to the fourth embodiment. The processing illustrated in FIG. 19 is based on the main object determination processing described in the first embodiment with reference to FIGS. 7A and 7B, and differs in that step S1901 has been added, and that steps S715 and S716 have been replaced with steps S1902 to S1904. Because the other steps are the same, the processing from steps S704 to S714 will be treated as the initial main object determination processing of step S1900, and will therefore not be described.

The processing from steps S1901 to S1904 will be described hereinafter.

In step S1901, as the processing performed after the initial main object region has been determined in step S1900, the system control unit 102 sets a main object change prohibition timer to a predetermined length of time (ms) and starts the countdown of the timer. The system control unit 102 then ends the main object determination processing for the initial frame. The predetermined length of time is set to a fixed length of time, such as 3000 ms, for example. Alternatively, the camera settings are such that the user can set a high or low aggressiveness for changing the object, with the timer being shortened if the aggressiveness for changing the object is set high and the timer lengthened if the aggressiveness of changing the object is set low. Furthermore, in a mode that does not allow a change from the main object arbitrarily selected by the user, the timer is set to a length of time equivalent to infinity.

In step S1902, the system control unit 102 refers to the arbitrarily selected object flag 804 of the main object region which is currently set, and moves the processing to step S1903 if the flag is “true”, and to step S717 if the flag is “false”. As a result of this branch, the processing of the subsequent steps S1903 to S1904 is only executed when the object currently being tracked is an object which has been arbitrarily selected by the user.

In step S1903, the system control unit 102 obtains the remaining time of the main object change prohibition timer that started counting down in step S1901 in the initial frame, and the processing moves to step S1904 if the timer has not yet reached 0 ms. However, if the remaining time of the main object change prohibition timer is 0 ms, the system control unit 102 moves the processing to step S717.

In step S1904, of the main object candidate regions extracted from the current frame in step S701, the system control unit 102 removes the main object candidate regions aside from the main object candidate regions based on object tracking from the main object candidates, after which the processing moves to step S717.

As such, if the processing has proceeded to step S717 through step S1904, the main object will not be changed.

In the fourth embodiment, when the main object to be tracked is an object arbitrarily selected by the user, the main object is not changed until the predetermined length of time has elapsed from when the first switch SW1 was turned on.

This makes it possible to suppress situations where the main object is needlessly changed from a main object arbitrarily selected by the user, and makes it possible to implement main object selections and main object changes consistent with the user's intentions. For example, if the user has arbitrarily selected a main object and started tracking AF, immediately changing the main object simply because there is another object, aside from the main object arbitrarily selected by the user, which has a high main object suitability, would be inconsistent with the user's intentions. Therefore, by prohibiting the main object from being changed for a predetermined length of time after the start of tracking AF, and then selecting the main object based on the main object suitability after the predetermined length of time has elapsed, the main object can be selected according to the user's intentions.

According to the main object determination processing of the fourth embodiment, when the main object to be tracked has been arbitrarily selected by the user, changes in the object being tracked are suppressed until a predetermined length of time has elapsed following the point in time when the tracking was started. Through this, main object selections and main object changes which are consistent with the user's intentions can be realized even during continuous capturing in a tracking AF mode.

### Fifth Embodiment

A fifth embodiment will be described hereinafter.

The fifth embodiment will describe a method which changes a main object in a manner consistent with a user's intentions by suppressing a change in a main object arbitrarily selected by the user while that main object is being tracked, through a method different from that used in the first to fourth embodiments. To summarize, the fifth embodiment describes an example in which when calculating the main object suitability, weighting coefficients included in the calculation formula are set dynamically so that the main object suitability is highest for a main object arbitrarily selected by the user.

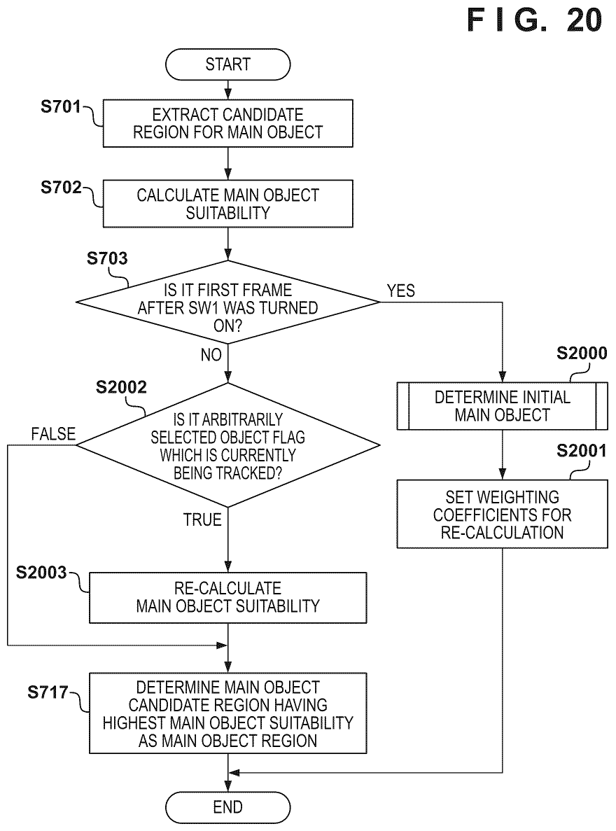

The fifth embodiment differs from the first embodiment only in terms of the algorithm for the main object determination performed in step S409, and the other configurations are the same. As such, the algorithm for the main object determination performed in step S409 according to the fifth embodiment will be described next with reference to FIG. 20.

FIG. 20 is a flowchart illustrating the main object determination processing performed in step S409 according to the fifth embodiment. The processing illustrated in FIG. 20 is based on the main object determination processing described in the first embodiment with reference to FIGS. 7A and 7B, and differs in that step S2001 has been added, and that steps S715 and S716 have been replaced with steps S2002 and S2003, respectively. Because the other steps are the same, the processing from steps S704 to S714 will be treated as the initial main object determination processing of step S2000, and will therefore not be described.

The processing from steps S2001 to S2003 will be described hereinafter.

In step S2001, as the processing performed after the initial main object region has been determined in step S2000, the system control unit 102 sets weighting coefficients for re-calculating the main object suitability, which is performed in the subsequent step S2003 for a subsequent frame. The setting of the weighting coefficients for the re-calculation will be described in detail later. The weighting coefficients used to re-calculate the main object suitability in step S2003 will be called “weighting coefficients for re-calculation” to distinguish those coefficients from the weighting coefficients used in step S702.

In step S2002, the system control unit 102 refers to the arbitrarily selected object flag 804 of the main object region which is currently set, and moves the processing to step S2003 if the flag is “true”, and to step S717 if the flag is “false”. As a result of this determination, the processing of the subsequent step S2003 is only executed when the object currently being tracked is an object which has been arbitrarily selected by the user.

In step S2003, the system control unit 102 invalidates the main object suitability of each main object region calculated in step S702 and re-calculates the main object suitability, after which the processing moves to step S717.

Formula 2 indicates a formula used for re-calculating the main object suitability. Formula 2 is basically the same as Formula 1 used in step S702, but the weighting coefficients 1, 2, and 3 have been replaced with the weighting coefficients 1, 2, and 3 for re-calculation set in step S2001.

main object suitability=(α×weighting coefficient 1 for re-calculation)+(β×weighting coefficient 2 for re-calculation)+(γ×weighting coefficient 3 for re-calculation) Formula 2

Then, in step S717, the main object region is determined on the basis of the re-calculated main object suitability, if the processing has progressed through step S2003.

The setting of the weighting coefficients for re-calculating the main object suitability in step S2001 will be described next.

First, the system control unit 102 determines whether or not the main object region determined in step S2000 is a region corresponding to the face of a person. Then, if the region corresponds to the face of a person, the weighting coefficient 1 for re-calculation is set to a numerical value equivalent to the weighting coefficient 1 used in step S702. On the other hand, if the region does not correspond to the face of a person, the weighting coefficient 1 for re-calculation is set to a predetermined numerical value less than the weighting coefficient 1 used in step S702. Accordingly, even if a main object arbitrarily selected by the user is not the face of a person, the main object suitability is less likely to decrease in the re-calculation of the main object suitability of step S2003, and thus a situation where the main object changes from the main object arbitrarily selected to another object can be suppressed. The user having selected an object aside from a person as the main object means that it is likely that from the user's perspective, the main object is not limited to people, and thus setting the weighting coefficients in this manner is useful in terms of realizing main object selections which are consistent with the user's intentions.

Next, the system control unit 102 calculates a distance of the main object from the camera on the basis of the focus state of the main object region determined in step S2000. Then, the weighting coefficient 2 for re-calculation is set, using the weighting coefficient 2 used in step S702 as a reference, to be higher the closer the main object is to the camera, and lower the farther the main object is from the camera. Accordingly, even if a main object arbitrarily selected by the user is far from the camera, the main object suitability is less likely to decrease in the re-calculation of the main object suitability of step S2003, and thus a situation where the main object changes from the main object arbitrarily selected to another object can be suppressed. The fact that the user has selected an object far from the camera as the main object can be considered to indicate that the distance from the camera is a factor of relatively low importance to the user, and thus setting the weighting coefficients in this manner is useful in terms of realizing main object selections which are consistent with the user's intentions.

Finally, the system control unit 102 obtains the position, in the viewfinder screen 131, of the main object region determined in step S2000. Then, the weighting coefficient 3 for re-calculation is set, using the weighting coefficient 3 used in step S702 as a reference, to be higher the closer the main object region is to the center of the viewfinder screen 131, and lower the further the main object region is from the center of the viewfinder screen 131. Accordingly, even if a main object arbitrarily selected by the user is located at an end of the viewfinder screen 131, the main object suitability is less likely to decrease in the re-calculation of the main object suitability of step S2003, and thus a situation where the main object changes from the main object arbitrarily selected to another object can be suppressed. The fact that the user has selected an object located at an end of the image capturing screen as the main object can be considered to indicate that the location in the image capturing screen is a factor of relatively low importance to the user, and thus setting the weighting coefficients in this manner is useful in terms of realizing main object selections which are consistent with the user's intentions.

In the present embodiment, when the main object to be tracked is an object which has been arbitrarily selected by the user, adjusting the weighting coefficients used in the formula for calculating the main object suitability suppresses a situation in which the main object is needlessly changed from the main object arbitrarily selected by the user.

According to the main object determination processing of the fifth embodiment, when the main object to be tracked has been arbitrarily selected by the user, changes in the object to be tracked are suppressed by switching the method for calculating the suitability on the basis of the state of the object being tracked at the point in time when the tracking was started. Through this, main object selections and main object changes which are consistent with the user's intentions can be realized even during continuous capturing in a tracking AF mode.

Note that in the foregoing first to fifth embodiments, control may be performed so that the main object is permitted to be changed when a predetermined condition other than the suitability of the object is satisfied. In this case, the predetermined condition is, for example, when the object arbitrarily selected by the user is obscured by something and cannot be seen, when a rapid pan of the camera is detected and the object arbitrarily selected by the user can no longer be seen, and so on.

### Other Embodiments

The present invention is not limited to the examples described in the foregoing first to fifth embodiments, and it is also possible to combine parts of the first to fifth embodiments as appropriate. The present invention can also be implemented, for example, by using an image signal output from the image sensor 111, instead of the AE image signal, as the image signal for tracking AF processing and object detection processing in the live view mode. The present invention can also be implemented in an image capture apparatus which lacks an optical viewfinder, such as a mirrorless camera, by similarly using an image signal output from the image sensor 111.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-210632, filed Nov. 21, 2019 which is hereby incorporated by reference herein in its entirety.

What is claimed is:

1. An object tracking apparatus comprising:
a tracking unit configured to perform tracking processing that takes a predetermined object in images captured in succession as a tracking target;
a setting unit configured to set an object as the tracking target in accordance with a user operation;
a determining unit configured to determine an object as the tracking target on the basis of at least one of the images; and
a control unit configured to perform control so that, in control that changes a current tracking target to the object determined by the determining unit, it is more difficult for the tracking target to be changed when the current tracking target has been set by the setting unit than when the current tracking target has not been set by the setting unit.
